(19) United States
(12) Patent Application Publication
(10) Pub. No.: US 2020/0130838 A1
(43) Pub. Date: Apr. 30, 2020

(54) SYSTEM AND METHOD FOR PROVIDING PASSENGER INTERFACES

(71) Applicant: BOMBARDIER INC., Dorval (CA)

(72) Inventors: Nikolas BEAUDIN, Montreal (CA); Seung Joon BANG, Laval (CA); Louis GAGNON-SEGUIN, Montreal (CA); Thomas FINKHELSTEIN, Pierrefonds (CA); Omar MASAUD, Ottawa (CA); Mojtaba AHMADI, Ottawa (CA); Darren O'NEILL, Kanata (CA); Chantal Marie-Josee TRUDEL, Ottawa (CA)

(21) Appl. No.: 16/665,710

(22) Filed: Oct. 28, 2019

Related U.S. Application Data
(60) Provisional application No. 62/752,475, filed on Oct. 30, 2018.

(51) Int. Cl. B64D 11/00; B64D 11/06

(52) U.S. Cl. CPC B64D 11/00; B64D 11/06; B64D 11/0015

(57) ABSTRACT

A system for providing a passenger interface for a passenger in a seat including at least one sensor adapted to generate a signal representative of the position, the configuration, and/or the direction of movement of hand of the passenger; a controller, and a projector for projecting a passenger interface, placement of which is determined based at least on the signal. A method includes receiving a first signal indicative of a position and/or an arm of the passenger; projecting, by a projector, a passenger interface onto a predetermined surface, the passenger interface location on the predetermined surface being based on the first signal, receiving a second signal indicative of the position, configuration, and/or direction of movement of the passenger's hand of with respect to the passenger interface; and adjusting at least one of a passenger controllable feature, and projection of at least one media display by a second projector.

### CROSS-REFERENCE

The present application claims convention priority to U.S. Provisional Patent Application No. 62/752,475, filed Oct. 30, 2018, entitled “SYSTEM AND METHOD FOR PROVIDING PASSENGER INTERFACES” which is incorporated by reference herein in its entirety.

### FIELD OF TECHNOLOGY

The present technology relates to systems and methods of providing interfaces in a vehicle. More specifically, the present technology is directed to the providing projected interfaces and sensing passenger interaction with those projected interfaces.

### BACKGROUND

Passenger transportation, including aircraft for example, include an ever increasing variety of features for controlling passenger comfort and experience, as well as information and entertainment media. For example, passengers often have access to cabin features such as light and air flow, internet accessing interfaces such as browsers on computer or touch screens, and visual media such a movies or television shows.

The physical structures for passenger interaction with controls and media, such as buttons or touch screens, tend to have a limited life span and a high replacement cost. Passenger interactions tend to cause wear and tear damage to these apparatuses, necessitating replacement over time. Further, style changes and technological advances can lead to even faster replacement of these physical structures, in order to satisfy passengers' desire for up to date technology.

The increasing numbers of interactive media structures lead not only to increased costs but also to a loss of space around the passenger. Vehicle cabins can become cluttered by the many buttons, touch screens etc. Further, each additional features can further necessitate buttons, controls, etc. in order for the passenger to switch between all of the different features.

Consequently, there is a desire for a configuration for a technology which provides interfaces with which passengers can interact, but without at least some of the above drawbacks.

### SUMMARY

It is an object of the present technology to ameliorate at least some of the inconveniences present in the prior art.

According to one aspect of the present technology, there is provided a system for providing interactive media and controls to a passenger. The system includes at least one gesture sensor and one or more projectors, such that passenger interaction with projected interfaces can be used to control both the interactive projections, as well as cabin features such as lights, sound systems, etc. As the interactive media, including for example control buttons for controlling the cabin features, are projected, they can easily be updated as styles or technologies change. In contrast, changing or updating physical buttons in a passenger vehicle (such as an aircraft) can be expensive and time-consuming.

Changing the physical buttons are further an inevitability, as the physical buttons, or physical interactive interfaces such as touch screens, because the physical structures wear over time and will break down or begin to malfunction from normal wear and tear. In contrast, projected buttons and interfaces have no moving parts to break or wear down.

Further, since the projected interfaces can easily be moved around, the interfaces can be ergonomically placed for each passenger, for example adapting to the physical size of each passenger. In some instances, the projected control buttons can be projected at a sensed position of the passenger's hand. Additionally, while each additional feature in systems with physical interfaces consumes space around the passenger, projected interactive media interfaces allow for the interfaces to be hidden away when not in use.

According to an aspect of the present technology, there is provided a system for providing a passenger interface for a passenger in a seat. The system includes at least one sensor adapted to sense at least one of: a position of at least one hand of the passenger, a configuration of the at least one hand of the passenger, and a direction of movement of the at least one hand of the passenger, the at least one sensor being adapted to generate a signal representative of the at least one of the position of the at least one hand of the passenger, the configuration of the at least one hand of the passenger, and the direction of movement of the at least one hand of the passenger; a controller communicatively connected to the at least one sensor for receiving at least the signal therefrom, the controller being communicatively connected to at least one passenger controllable feature, the controller being adapted to control the at least one passenger controllable feature based on the signal representative of the at least one of the position of the at least one hand of the passenger, the configuration of the at least one hand of the passenger, and the direction of movement of the at least one hand of the passenger; and a projector communicatively connected to the controller, the projector being adapted to project a passenger interface onto a predetermined surface, placement of the projected passenger interface being determined by the controller based at least on the signal representative of the at least one of the position of the at least one hand of the passenger, the configuration of the at least one hand of the passenger, and the direction of movement of the at least one hand of the passenger.

In some embodiments, the at least one sensor is adapted to determine an intended interaction with the passenger interface by the passenger based on a placement of the at least one hand of the passenger on the predetermined surface.

In some embodiments, the at least one sensor is adapted to determine an intended interaction with the passenger interface by the passenger based on movement of the at least one hand of the passenger between the projector and the predetermined surface.

In some embodiments, the at least one passenger controllable feature includes at least one of: an overhead light; an air supply; a sound system with controllable volume; and a window shade system for selectively closing and opening a window shade.

In some embodiments, the projector is a first projector; the predetermined surface is a first predetermined surface. The system further includes a second projector communicatively connected to the controller, the second projector being adapted for projecting at least one media display onto a second predetermined surface.

In some embodiments, the first predetermined surface is a ledge generally adjacent to the seat; and the second predetermined surface is a table top.

In some embodiments, at least a portion of the second predetermined surface is selectively moveable between at least a horizontal position and a tilted position; and the second projector is adapted to project the at least one media display onto the portion when the portion is arranged in the horizontal position and when the portion is arranged in the tilted position.

In some embodiments, the second predetermined surface is selectively moveable between at least a deployed position and a stored position, the second projector being adapted to project the at least one media display onto the second predetermined surface only when the second predetermined surface is arranged in the deployed position.

In some embodiments, the system further includes a third projector for projecting a visual media onto a wall surface disposed generally opposite the seat, the third projector being communicatively connected to the controller.

In some embodiments, the visual media is at least a portion of the at least one media display projected by the second projector.

In some embodiments, the system further includes at least one seat sensor communicative connected to the controller, the at least one seat sensor being adapted for determining at least one of: a translational position of the seat; a recline angle of the seat; and a presence of the passenger in the seat.

In some embodiments, the system further includes at least one passenger sensor communicatively connected to the controller, the passenger sensor being adapted to determine at least one of: a position of a head of the passenger; a position of a body of the passenger; and a change in position of at least one of the head of the passenger and the body of the passenger.

In some embodiments, the passenger interface projects buttons for controlling at least one of: a passenger controllable feature; and an additional projector for projecting at least one media display onto a surface near the seat.

According to another aspect of the present technology, there is provided a system for providing a plurality of passenger interfaces for a passenger in a seat. The system includes a first projector for projecting a button display onto a side ledge disposed near the seat; a second projector for projecting a first media display onto a table top disposed near the seat; a third projector for projecting a second media display onto a side wall opposite the seat; at least one sensor adapted to sense at least one of: a position of at least one hand of the passenger, a configuration of the at least one hand of the passenger, and a direction of movement of the at least one hand of the passenger, with respect to at least one of the button display and the first media display; and a controller communicatively connected to the first projector, the second projector, the third projector, and the at least one sensor.

According to another aspect of the present technology, there is provided a method for providing a passenger interface to a passenger in a seat. The method includes receiving, by a controller from at least one sensor, a first signal indicative of at least one of: a position of the hand of the passenger, and a position of an arm of the passenger; projecting, by a projector, a passenger interface onto a predetermined surface, a location of the passenger interface on the predetermined surface being based on the first signal; receiving, by the controller from the at least one sensor, a second signal indicative of at least one of a position of the hand of the passenger with respect to the passenger interface, a configuration of the hand of the passenger with respect to the passenger interface, and a direction of movement of the hand of the passenger with respect to the passenger interface; and adjusting, by the controller, based on the second signal, at least one of: a passenger controllable feature, and projection of at least one media display by a second projector communicatively connected to the controller.

In some embodiments, the passenger interface is a projected button display.

In some embodiments, the second signal is indicative of the position of the hand of the passenger on the predetermined surface.

In some embodiments, the second signal is indicative of at least one of the position, the configuration, and the movement of the hand of the passenger between the predetermined surface and the at least one sensor.

In some embodiments, the projector is a first projector; the predetermined surface is a first predetermined surface. The method further includes projecting, by a second projector, at least one media display onto a second predetermined surface.

In some embodiments, the second predetermined surface is selectively moveable between at least a deployed position and a stored position; and the method further includes detecting, by the at least one sensor, that the second predetermined surface is in the stored position; and sending, from the controller to the second projector, a signal to control the second projector to stop projecting the at least one media display.

In some embodiments, at least a portion of the second predetermined surface is selectively moveable between at least a horizontal position and a tilted position; and the method further includes detecting, by the at least one sensor, that the portion of second predetermined surface is in the tilted position; and adjusting the projection of the at least one media display, by the second projector, to project the at least one media display onto the portion in the tilted position.

In some embodiments, the method further includes projecting, by a third projector, a visual media onto a third predetermined surface.

In some embodiments, the method further includes receiving, by the controller from the at least one sensor, a third signal indicative of at least one of a position of the hand of the passenger with respect to the media display projected onto the second predetermined surface, a configuration of the hand of the passenger with respect to the media display projected onto the second predetermined surface, and a direction of movement of the hand of the passenger with respect to the media display projected onto the second predetermined surface; and projecting, by a third projector, a visual media onto a third predetermined surface, based on the third signal.

In some embodiments, the method further includes controlling the second projector to stop projecting the at least one media display onto the second predetermined surface when the third projector begins projecting the visual media onto the third predetermined surface.

In some embodiments, the method further includes receiving, by the controller from at least one seat sensor, a fourth signal indicative of at least one of: a translational position of the seat, a recline angle of the seat, and a presence of the passenger in the seat; and adjusting projection of at least one of the first projector, the second projector, and the third projector based at least on the fourth signal.

In some embodiments, the method further includes receiving, by the controller from at least one passenger sensor, a fourth signal indicative of at least one of: a position of a head of the passenger, a position of a body of the passenger, and a change in position of at least one of the head of the passenger and the body of the passenger; and adjusting projection of at least one of the first projector, the second projector, and the third projector based at least on the fourth signal.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top plan view of an aircraft;

FIG. 2 is a side view of a portion of a passenger cabin of the aircraft of FIG. 1;

FIG. 3 is a cross-sectional view of the passenger cabin of FIG. 2;

FIG. 4 is a partial cut-away view of the passenger cabin of FIG. 2;

FIG. 5 is a schematic diagram of a system for providing a passenger interface in the passenger cabin of FIG. 2, according to one embodiment of the present technology;

FIG. 6 is a close-up view of portions of the passenger cabin of FIG. 2, with a table in a horizontal position;

FIG. 7 is the close-up view of the portions of the passenger cabin of FIG. 6, with the table in a tilted position;

FIG. 8 is a schematic diagram of a system for providing a passenger interface in the passenger cabin of FIG. 2, according to another embodiment of the present technology;

FIG. 9 is the cross-sectional view of the passenger cabin of FIG. 2, with the system of FIG. 8; and

FIG. 10 is a flow chart of a method of providing a passenger interface according to the present technology.

It should be noted that the Figures are not drawn to scale, unless otherwise noted.

### DETAILED DESCRIPTION

The present technology will now be described in connection with one or more embodiments. The discussion of any one particular embodiment or associated feature is not intended to be limiting of the present invention. To the contrary, the discussion of particular embodiments and features is intended to illustrate the breadth and scope of the present invention. There are numerous variations and equivalents that will be made apparent from the discussion that follows. Those variations and equivalents are intended to be encompassed by the scope of the present invention as if described herein.

With respect to various features that are discussed in connection with specific embodiments, it is noted that the features are not intended to be exclusive of one another. To the contrary, as should be apparent to those skilled in the art, several of the features may be combinable in arrangements that differ from the specific embodiments described below. Those combinations are contemplated to fall within the scope of the present invention.

The present technology will be described with respect to aircraft, but it is contemplated that all or some of the aspects of the technology could be applied to other passenger vehicles, including but not limited to: trains, automobiles, and ships.

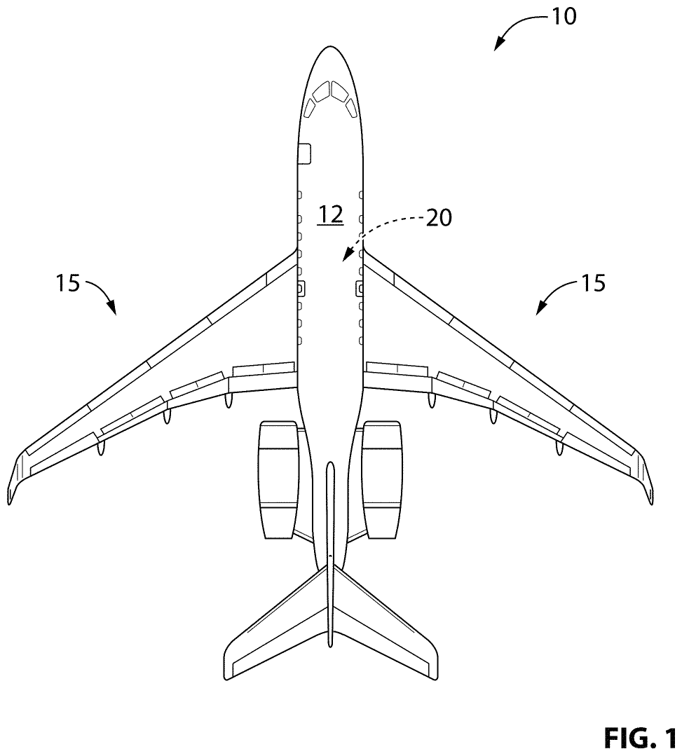

FIG. 1 shows a top view of a fixed-wing jet aircraft 10 according to the present technology. The aircraft 10 includes a fuselage 12 (the body of the aircraft 10). Connected to the fuselage 12 are two oppositely disposed wing assemblies 15, also referred to herein as wings 15. The wings 15 produce lift and therefore flight of the aircraft 10 during operation. The illustrated aircraft 10 is simply an example of an aircraft implementing an embodiment of the present technology; it is not meant to be limiting.

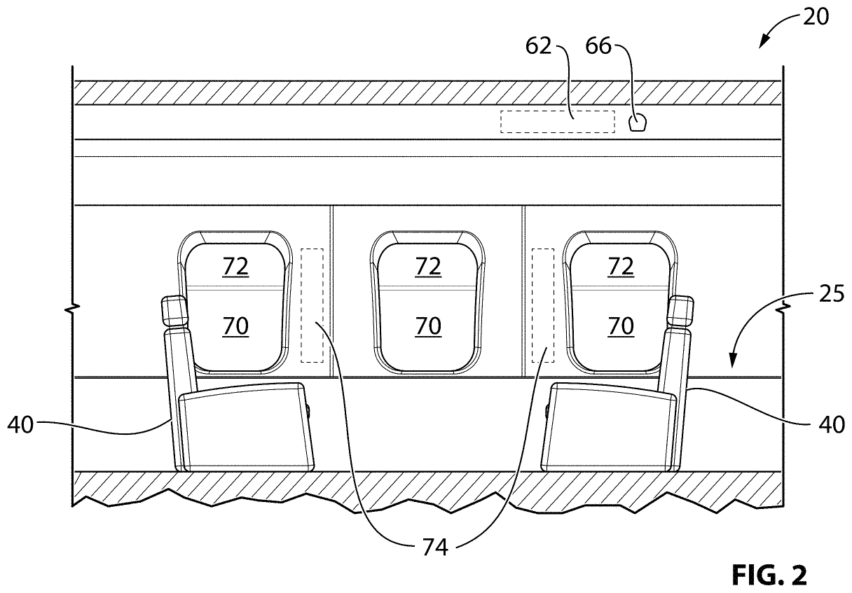

Within the fuselage 12 is a passenger cabin 20, portions of which are illustrated in FIGS. 2 to 4. There are a plurality of passenger seats 40 in the cabin 20. The number and relative orientations of the seats 40 depend on the specific embodiment, and are not limited to the arrangement illustrated in the Figures. The fuselage 12 includes a plurality of windows 70 extending through to the passenger cabin 20. The cabin 20 could include more or fewer windows 70 than is illustrated in the Figures, depending on the specific embodiment of the aircraft 10.

The passenger cabin 20 includes a side ledge 25 that extends along a cabin side wall 22, disposed next to one side of each seat 40. Depending on the specific embodiment, the side ledge 25 could extend along only portions of the cabin 20. It is also contemplated that the side ledge 25 could extend along all or portions of only one side wall 22, depending on the specific embodiment of the aircraft 10.

The passenger cabin 20 further includes a table 30, extending outward from the wall 22. The table 30 is disposed between two facing seats 40, but it is contemplated that each seat 40 could have its own table 30. It is also contemplated that the cabin 20 could include more or fewer tables 30. In some embodiments, the table 30 could be connected to the floor of the cabin 20, rather than extending from the wall 22. In some other embodiments, the table 30 could be movably connected to its corresponding seat 40. The size, style, and form of the table 30 is not meant to be limited by the table 30 illustrated in the Figures.

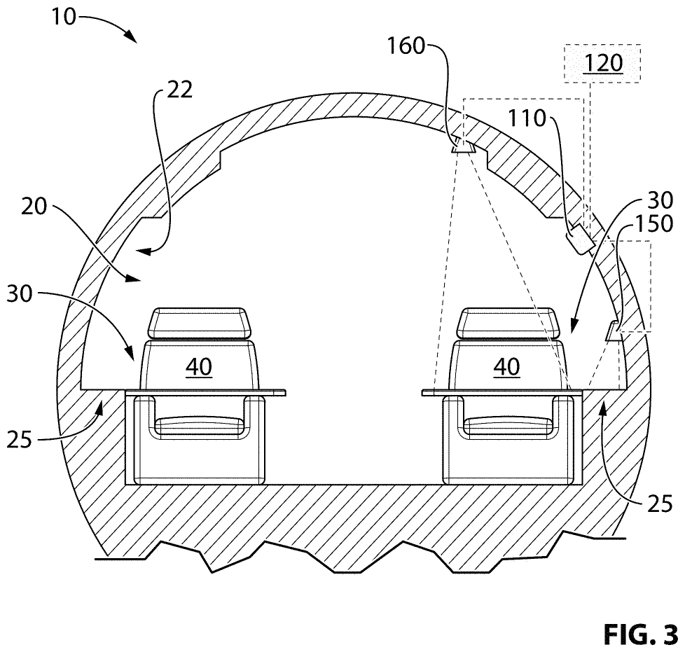

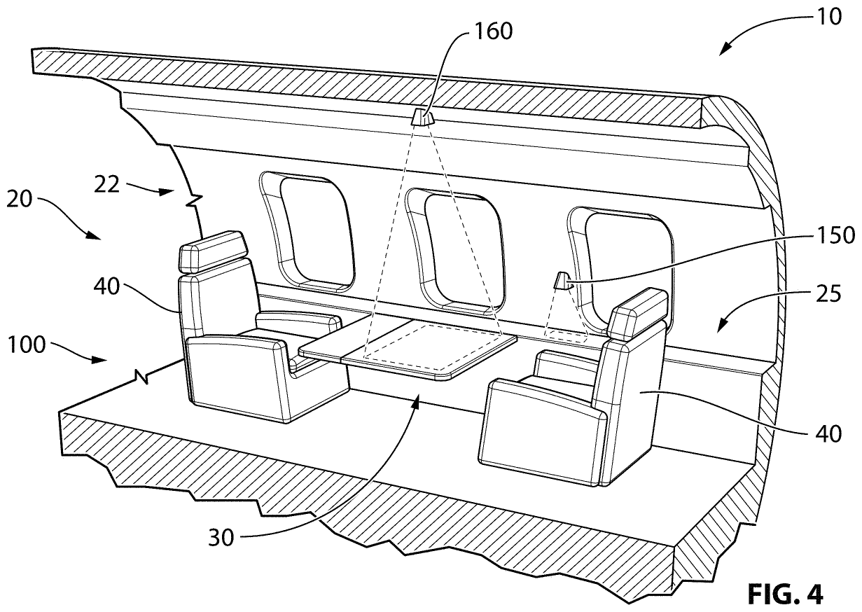

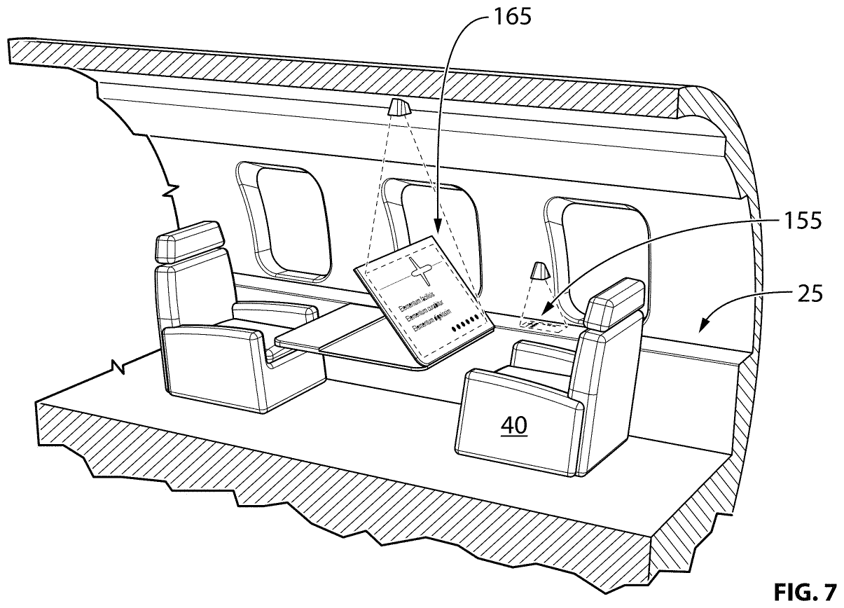

The table 30 is selectively deployable, such that the table 30 can be stored away when desired by the passenger. In FIG. 2, the table 30 has been put away, arranged in a stored position. In FIGS. 3 and 4, the table 30 is illustrated in a deployed position, out and ready for use by the passenger. The table 30 includes a tiltable portion 32, shown in a tilted position in FIG. 7. The tiltable portion 32 of the table 30, and use thereof, will be described in more detail below.

The passenger cabin 20 further includes several passenger controllable features, These features may also be collectively referred to as “comfort parameters” or “passenger services” with respect to the present technology. These features have been illustrated only in FIG. 2 for clarity of the Figures; it is contemplated that the features are equally present in the remaining Figures but are not shown to avoid overcrowding of the illustrations. Control of these features will be described in more detail below with reference to a system 100. The passenger controllable features described herein are non-limiting examples of such features. Inclusion and control of different, alternative, or additional features is contemplated.

As illustrated in FIG. 2, each window 70 has a passenger controllable window shade 72. The windows 70 are positioned adjacent and between the seats 40, as might be expected for a typical layout of a cabin 20 for an aircraft. The cabin 20 could include more or less windows 70 than illustrated, depending on the embodiment of the cabin 20 or the aircraft 10. The window shade 72 may be a physical shade (i.e., a light-impermeable flexible material) that blocks the transmission of light through the window 70. Alternatively, the window shade 72 may be an electrochromic material (i.e., an electrochromic) film that alters the transmission of light through the window 70 by responding to an electrical signal applied thereto. Other types of window shades 72 also may be employed without departing from the scope of the present technology.

As also illustrated in FIG. 2, the cabin 20 includes one or more passenger controllable overhead light fixtures 62 disposed generally above at least one of the seats 40. The light fixtures 62 are contemplated to provide specific, task lighting (including light for reading) for a passenger in the seat 40. The overhead light fixtures 62 are contemplated to be LEDs, aspects of which may be adjusted by the passenger, such as its intensity and color, as will be described in more detail below.

As is also illustrated in FIG. 2, the cabin 20 includes a passenger controllable air nozzle 66 to direct an air flow toward its corresponding seat 40. While only one air nozzle 66 is illustrated, it is contemplated that one or more air nozzles 66 could be included for each seat 40 in the cabin 20. In connection with the air nozzle 66, its air flow direction, and its air flow rate, it is noted that each of these variables concern what is more generally referred to as the “air supply” provided within the cabin 20 of the aircraft 10. To avoid limiting the present technology solely to air provided via an air nozzle 66, the term “air supply” is used herein to encompass any structure, hardware, and/or software that may be employed to supply air within the cabin 20 of the aircraft 10. The air nozzle 66, therefore, represents one specific embodiment by which air may be supplied within the cabin 20 of the aircraft 10.

As is also illustrated in FIG. 2, the cabin 20 includes a passenger controllable sound system 74, embodied in the present non-limiting description as a speaker 74 disposed near its corresponding seat 40. The speakers 74 could be connected to a visual media system (described in more detail below), for example for providing sound for a movie. It is contemplated that the passenger controllable sound system 74 could take the form of a headphone jack for connecting headphones for listening to movie sounds, music, etc. It is also contemplated that the passenger controllable sound system 74 could include multiple speakers and/or speakers in conjunction with one or more headphone jacks.

In accordance with the present technology, the passenger cabin 20 includes a system 100 for providing one or more passenger interfaces for a passenger in one of the seats 40 and for controlling at least some of the passenger controllable features described above. In the present description, the system 100 will be described for only one of the seats 40, but it is contemplated that the cabin 20 could include multiple embodiments of the system 100. For example, in some embodiments of the aircraft 10, there could be included one system 100 for each passenger seat. Some different embodiments, it is also contemplated that one system 100 could provide interfaces for multiple seats 40.

The system 100 includes a controller 120 for controlling and managing different portions of the system 100. The controller 120 is generally any computer-implemented device capable of performing the computational tasks descried herein. In some embodiments, the controller 120 could be embodied as a processor within a computer system of the aircraft 10. It is contemplated that the controller 120 could be integral with other control systems of the aircraft 10. It is also contemplated that the controller 120 could be a stand-along computational device disposed in the infrastructure of the aircraft 10.

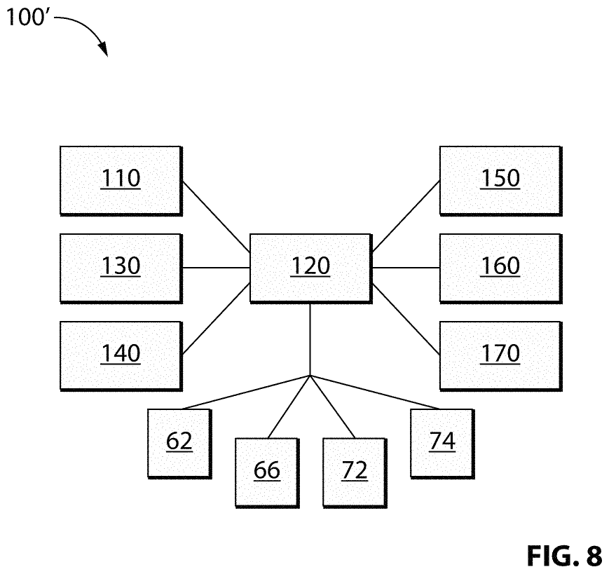

The system 100 also includes a sensor 110, specifically a gesture control sensor 110, communicatively connected to the controller 120. The sensor 110 senses at least one of a position, direction of movement, and a configuration of one or more passenger hands. In some embodiments, the sensor 110 includes a camera and image treatment system to determine hand position, movement, and gestures. By sensing the passenger's hand or hands, the sensor 110 detects passenger interaction with passenger interfaces in the cabin 20, as will be described in more detail below. In some embodiments, it is contemplated that the sensor 110 could further sense a head position of the passenger, a body position of the passenger, and/or a change in the head or body position. It is also contemplated that the system 100 could include a separate sensor for sensing the head and/or body position of the passenger. As is mentioned later, it is further contemplated that one or more of the seats 40 could include a seat position sensor 140 (see for example FIG. 8 and related description below).

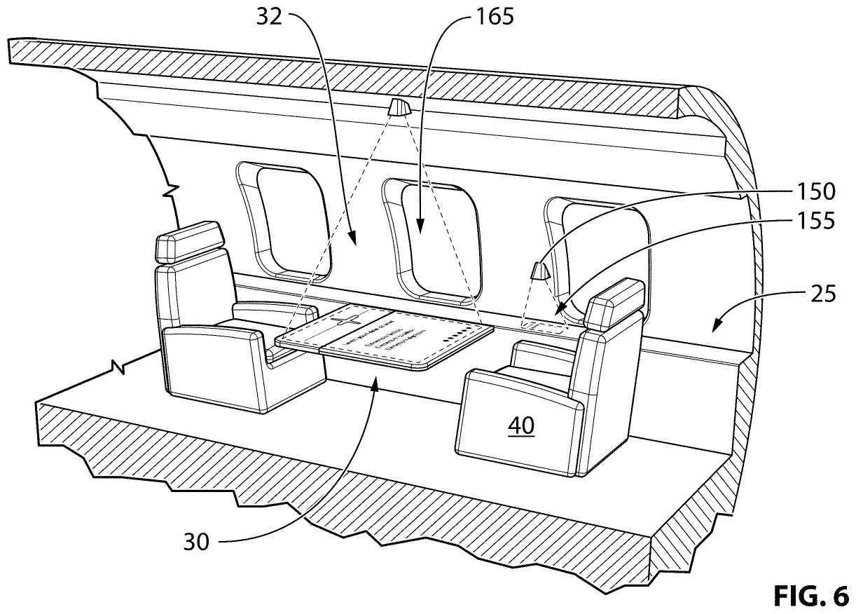

With further reference to FIGS. 6 to 7, the system 100 further includes a projector 150 for projecting a first passenger interactive display 155 on to the side ledge 25. The projector 150 is a picoprojector, although different types of projectors could be utilized depending on the specific embodiment.

The projector 150 is operatively connected to the controller 120. The first passenger interactive display 155 is specifically an image buttons for controlling at least one of the passenger controllable features described above. It is contemplated that the projected display 155 could additionally or alternatively include sliders and virtual knobs for controlling the passenger controllable features. In some embodiments, the passenger interactive display 155 could be projected onto the table 30, rather than the side ledge 25. In some embodiments, the passenger interactive display 155 could be projected onto either the table 30 or the side ledge 25 depending on input from the passenger. It is further contemplated that the passenger interactive display 155 could be projected onto a different predetermined surface.

The sensor 110 detects passenger interaction with the projected passenger interactive display 155 by sensing positioning, movement, and/or configuration of the passenger hand in relation to the display 155. Specifically, the sensor 110 generates a signal based on the passenger hand either on the side ledge or between the side ledge 25 and the projector 150 to control passenger controllable features (described further below). Depending on the specific embodiment and passenger preferences, the sensor 110 creates the control signal based on the passenger actually touching the side ledge 25 (as if the projected buttons of the display 155 were regular buttons) or by the passenger moving their hands above the display 155.

The system 100 also includes an overhead projector 160 for projecting one or more visual media interfaces 165 onto a top surface of the table 30. The projector 160 is operatively and communicatively connected to the controller 120. As is illustrated in FIGS. 6 and 7, the interface 165 is used to present an internet browsing experience, but it can equally be used to present a movie, television show, or information related to the flight. In summary, the projected media interface 165 presents information and allows for interaction similar to a touch-screen interface, as is readily recognizable in passenger vehicles. In contrast to those screens, however, the sensor 110 detects passenger interactions with the interface 165, by sensing the position, movement and/or gesture of the passenger's hand, as will be described in more detail below. In some embodiments, it is contemplated that the same projector 160 could provide the visual media 165 as well as the passenger interactive display 155.

As is mentioned briefly above, the table 30 includes a selectively tiltable portion 32. The tiltable portion 32 can be arranged in a horizontal position such that the portion 32 is aligned with the remaining portions of the table 30, as is illustrated in FIG. 6. The tiltable portion 32 can also be arranged in a tilted position, as is illustrated in FIG. 7, such that the portion 32 is at an angle to the remaining portions of the table 30. It is contemplated that the tiltable portion 32 could make up more or less of the table 30 than illustrated. It is also contemplated that the tiltable portion 32 could have additional positions, or could be selectively positioned at any angle between horizontal and vertical.

According to the present technology, the sensor 110 is further adapted to sense the position of the tiltable portion 32, and the sense when the passenger has re-positioned the tiltable portion 32 by sensing the positioning and/or movement of the tiltable portion 32. Having sensed the position of the tiltable portion 32, the sensor 110 generates a signal indicating the position which is then sent to the projector 160 to adapt the visual media interface 165 such that it is correctly projected onto the table 30 and/or the tiltable portion 32. As can be seen in FIG. 7, the visual media interface 165 is resized and adjusted in order to appear correctly sized and in focus on the angled tiltable portion 32.

As is also mentioned above, the table 30 can be stowed away in some embodiments. The sensor 110 is further adapted to sense the overall position of the table 30. When the sensor 110 determines that the table 30 is stowed away, the sensor 110 further generates a signal indicating to the projector 160 to stop projecting the visual media interface 165. It is contemplated that the sensor 110 could generate the signal indicating to the projector 160 to stop projecting the visual media interface 165 in response to hand gestures from the passenger.

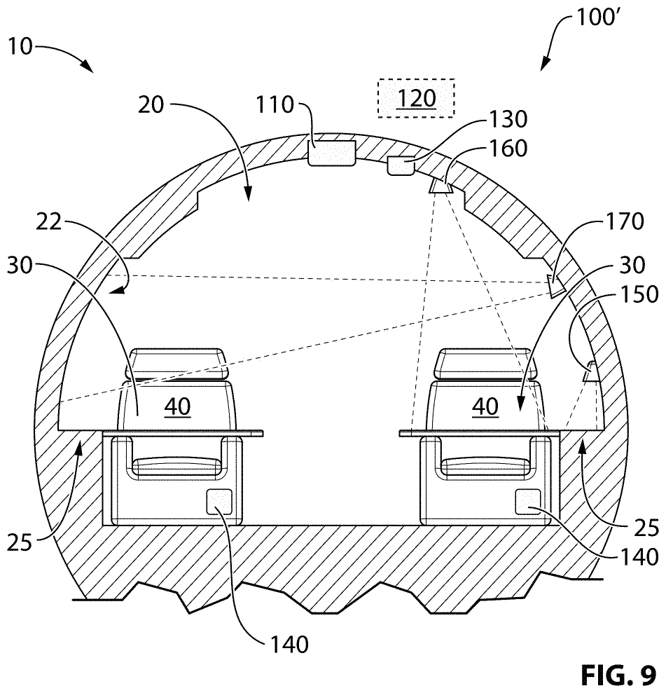

With reference to FIGS. 8 and 9, another embodiment of a system 100′ is illustrated. Elements of the system 100′ that are the same as or similar to elements of the system 100 retain their same reference numeral and will not be described again unless necessary. The system 100′ retains the controller 120, the gesture sensor 110, and the projectors 150, 160 of the system 100. It is contemplated that some embodiments of the system 100′ could include only one of the projectors 150 and 160.

The system 100′ includes an additional projector 170, referred to herein as a wall projector 170, communicatively connected to the controller 120. As is illustrated in FIG. 8, the wall projector 170, projects another visual media onto the cabin side wall 22 disposed generally opposite its corresponding seat 40. Depending on the indications received from the passenger, as will be discussed in more detail below, the visual media projected onto the side wall 22 could be the same visual media 165 as projected by the projector 160, or could be a different visual media. It is also contemplated that the projector 170 could be differently oriented to project onto a different surface, for example a wall or screen forward of the seat 40, depending on the particular embodiment.

The system 100′ also includes a seat sensor 140 communicatively connected to the controller 120. The seat sensor 140 detects a translational position of the seat 40, a recline angle of the seat 40, and/or a presence of the passenger in the seat 40. In some embodiments, the seat sensor 140 could additionally or alternatively sense changes to any or all of the position, angle, or presence of the passenger in the seat 40. The sensor 140 is adapted to generate signals based on the passenger seat information sensed by the sensor 140, such that the controller 120 can control the projectors 150, 160, 170 based on the sensed seat position or passenger presence. For example, upon sensing by the sensor 140 that the passenger seat has rotated away from the side ledge 25, the controller 120 can control the projector 150 to stop projecting the interface 155 onto the side ledge 25 (as it is no longer needed). Similarly, in some embodiments, if the sensor 140 senses that the passenger has left the seat 40, the controller 120 can control all of the projectors 150, 160, 170 to stop projecting any of the projected media.

The system 100′ further includes a passenger sensor 130 adapted to determine one or more of a head position of the passenger, a body position of the passenger, and a change in either of the head or body position. Similar to the sensor 110, the sensor 130 includes a camera and image treatment system to determine the head and/or body position, or changes thereto, although a different type of sensor could be employed. In some embodiments, the sensor 130 could further sense eye movement of the passenger, in order to track where the passenger is looking. It is contemplated that the sensor 110 and the sensor 130 could be implemented as one sensor.

As may be apparent, reference to any one sensor or feature herein does not preclude more than one of the enumerated devices being used within the cabin 20 of the aircraft 10. For example, it is contemplated that the sensor 110 will be implemented as a plurality of sensors 110 disposed throughout the cabin 20 of the aircraft 10.

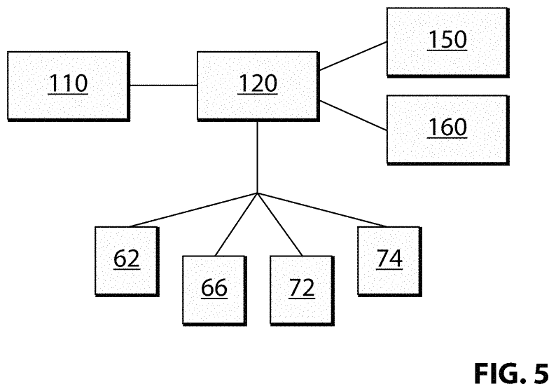

As also may be apparent from the foregoing, reference to communication lines in systems 100, 100′ between the elements 62, 66, 72, 74, 110, 130, 140, 150, 160, 170, as is schematically illustrated in FIGS. 5 and 9, is contemplated to refer to wired and/or wireless communication channels to and from the controller 120. In addition, the communication lines are contemplated to be two-way communication channels. Naturally, multiple one-way communication channels may be employed without departing from the scope of the present technology. In addition, a communication bus or a signal bus may be employed without departing from the scope of the present invention.

Use of the system 100′ (and by extension the system 100) will now be explained in more detail by way of the following examples of passenger interaction with the system 100′. It should be noted that these are simply illustrative examples to aid in understanding use of the systems 100, 100′ and should not be considered limiting in any way.

As one non-limiting example, the passenger may wish to watch a movie while sitting in the seat 40. The passenger begins by placing their hand on the side ledge 25. The sensor 110 detects the placement of the hand and sends a signal to the projector 150. In response, the projector 150 projects the button display 155. Placement of the button display 155 by the projector 150 is based on the detection by the sensor 110 of the location of the passenger's hand. As such, the position of the button display 155 is tailored to the passenger. In some embodiments, the sensor 110 could sense the position of the passenger's arm in order to determine placement of the button display 155.

The passenger then “pushes” a button on the button display 155 to turn on the visual media on their table 30 by tapping the side ledge 25 where the image of the appropriate button is projected. The sensor 110 senses the selection of the projected button, and generates a signal to the controller 120 indicating the selection. The controller 120 then controls the projector 160 to project the visual media 165 (the movie or a movie selection interface, for example) onto the table 30.

As another example interaction, the passenger now desires to lower the sound volume of the sound system 74, to make the movie quieter. The passenger points their finger toward the speaker 74 and motions downward. The sensor 110 senses the passenger's hand motion and sends a corresponding indication to the controller 120. The controller 120 in turn sends a signal to the speaker 74 to reduce the sound volume. The speaker 74 then reduces its sound volume in response to the signal sent from the controller 120. In another non-limiting example, the passenger could also use the button display 155. In such an embodiment, the passenger could slide their finger along a projected slider in the button display 155 to control the sound volume.

As another example interaction, the passenger could now decide to reduce the light in the cabin 20 in order to better see their movie. The passenger moves their hand in the direction of the window 70 in order to close the window shade 72. The passenger waves their hand in a downward motion and in the direction of the window 70. The sensor 110 senses the passenger's hand motion and sends a corresponding indication to the controller 120. The controller 120 in turn sends a signal to the window shade 72 to lower. The window shade 72 lowers to partially close the window 70 in response to the signal sent from the controller 120.

As another example interaction, the passenger now decides to watch their movie projected onto the side wall 22, instead of on the table 20. The passenger swipes their hand over the table 30 toward the side wall 22. The sensor 110 senses the passenger's hand motion and sends a corresponding indication to the controller 120. The controller 120 in turn sends a signal to the projector 170 to project the movie onto the side wall 22, as well as a signal to the projector 160 to stop projecting the movie onto the table 30. The projectors 160, 170 then operate as instructed in response to the signals sent from the controller 120. In some cases, the controller 120 could further instruct one of the projectors 150, 160 to project the button display 155 onto the table 30, such that it is accessible to the passenger, even if they are turned facing the side wall 22.

Later, the passenger could decide to no longer watch their movie on the side wall 22 and turn back to the table 30 to do other things. In such a case, the seat sensor 140 tracks the position and rotation angle of the seat 40, and sends a signal to the controller 120 that the passenger has turned their seat away from its position when watching the movie on the side wall 22. The controller 120 in turn sends a signal to the projector 160 to project the movie onto the table 30, as well as a signal to the projector 170 to stop projecting the movie onto the side wall 22. The projectors 160, 170 then operate as instructed in response to the signals sent from the controller 120. In some scenarios, the passenger sensor 130 could sense that the passenger has turned away from the side wall 22 and send a similar indication to the controller 120. In some scenarios, the controller 120 could direct the projector 170 to stop projecting the movie onto the side wall 22, but not instruct the projector 160 to project the movie onto the table 30.

In some scenarios, the passenger may decide to watch the movie on the table 30 with the tiltable portion 32 raised, for example to permit the passenger watch the movie while leaning back in their chair 40. The sensor 110 would then sense that the tiltable portion 32 was in the tilted position, and send a corresponding indication to the controller 120. The controller 120 would then control the projector 160 to project an image adapted to project onto the tilted portion 32. In some cases, the passenger could make adjustments to the angle of the tiltable portion 32 and the sensor 110, the controller 120, and the projector 160 could repeat their steps in order to allow the passenger to adjust the angle to get the best viewing position. In some cases, one of the projectors 150, 160 could project the playback controls, similar to the button display, onto the table 30 and/or the side ledge 25 to allow the passenger to control the movie.

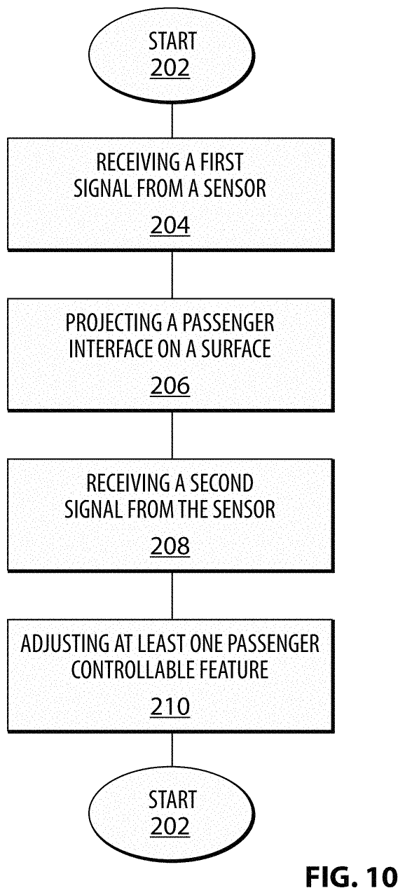

FIG. 10 is a flow chart illustrating one method 200 of operation of embodiments of the systems 100, 100′ of the present invention. It is noted that the method 200 is merely exemplary of innumerable variations that may be appreciated by those skilled in the art. The present invention is intended to encompass those variants, as if disclosed herein.

The method 200 for the systems 100, 100′ of the present invention contemplates cooperation, inter alia, between at least one of the sensors 110, 130, 140 and at least one of the passenger controllable features 62, 66, 72, 74, or at least one of the projectors 150, 160, 170. In one embodiment, the controller 120 is contemplated to receive and coordinate signals from each of the sensors 110, 130, 140 and control the passenger controllable features 62, 66, 72, 74, or the projectors 150, 160, 170 based on the inputs from the sensors 110, 130, 140.

The method 200 starts at 202.

Following the start at 202, the method 200 proceeds to step 204 where the first signal is received by the controller 120 from the sensor 110. As indicated above, the first input signal pertains to at least one of a position, and/or a configuration, and/or a direction of movement of the hand of the passenger. In some implementations, the first input signal could pertain to the position of the passenger's arm, and the passenger's arm and hand.

The method 200 then continues with step 206 where the projector 150 projects the passenger interface 155 onto a predetermined surface, for example the side ledge 25 or the table 30. The location of the passenger interface on the predetermined surface is based on the first signal. In some implementations, the passenger interface 155 is a projected button display 155.

The method 200 continues with step 208 where the controller 120 receives from the sensor 110 a second signal indicative of the position, and/or the configuration, and/or the direction of movement of the hand of the passenger with respect to the passenger interface 155. In some implementations, the signal will be indicative of the position, and/or the configuration, and/or the direction of movement of the hand of the passenger on the predetermined surface. In some implementations, the signal will be indicative of the position, and/or the configuration, and/or the direction of movement of the hand of the passenger in the space between the predetermined surface and the sensor 110.

The method 200 then continues with step 210 where the controller 120 adjusts one or more of the passenger controllable features and/or projection of one or more media displays by the projector 150 based on the signal received at step 208.

From step 210, the method 200 ends at step 212.

As should be apparent from the examples above, the method 200 does not generally fully terminate with step 212. Instead, the method 200 will generally restart from steps 204 and/or 208, depending on passenger interactions with the system 100, 100′.

In some implementations, the method 200 also includes projecting additional media onto another predetermined surface (for example the table 30 or the side wall 22) by another projector (for example the projector 160 or the projector 170). As is described above, the method 200 could further include projecting another visual media onto a third predetermined surface (for example the table 30 or the side wall 22) by another projector (for example the projector 160 or the projector 170). In either case, the method 200 could further include stopping projection of any one of the projectors 150, 160, 170 based on the projection of any one of the other projectors 150, 160, 170.

In some implementations, the method 200 could further include controlling the projectors 150, 160, 170 based on signals generated in response to the sensors 130, 140. In some such implementations, the method 200 could further include receiving, by the controller 120 from the seat sensor 140, another signal indicative of at least one of a translational position, and/or a recline angle, and/or a presence of the passenger in the seat 40. The method 200 would then continue with adjusting projection at least one of the projectors 150, 160, 170 based on the signal from the seat sensor 140. In some other such implementations, the method 200 could further include receiving, by the controller 120 from the passenger sensor 130, another signal indicative of at least one of a position of the head and/or the position of the body of the passenger, and/or a change in position of the head and/or the body of the passenger. The method 200 would then continue with adjusting projection of at least one of the projectors 150, 160, 170 based the signal from the passenger sensor 130.

In some such implementations, the method 200 further includes the sensor 110 detecting that the table 30 is in the stored position and then the controller 120 sending to the projector 160 a signal to stop projecting the media display 165.

In some other implementations, the method 200 further includes the sensor 110 detecting that the tiltable portion 32 of the table 30 is in the tilted position and then adjusting the projection of the visual media 165 to project the visual media 165 onto the tilted portion 32.

The method 200 may also be operational in a cyclic manner (i.e., 1 cycle per second or minute, etc.). As such, the method 200 is contemplated to be restarted from step 204 or step 208 repetitively. This assures that any passenger interactions, intended by the passenger to control different aspects of the cabin features and the projectors 150, 160, 170, are regularly detected in order respond to the passenger's interactions. Any cycle time may be selected for operation of the method 200, as required or as desired. The predetermined time interval of this cycle may be measured in millisecond, seconds, minutes, etc., as required or as desired.

The specification is not intended to limit the aspects of implementations and embodiments of the present technology as recited in the claims below. Modifications and improvements to the above-described implementations and embodiments of the present technology may become apparent to those skilled in the art. The foregoing description is intended to be exemplary rather than limiting.

What is claimed is:

1. A system for providing a passenger interface for a passenger in a seat, the system comprising:
at least one sensor adapted to sense at least one of:
a position of at least one hand of the passenger, and/or
a configuration of the at least one hand of the passenger, and/or
a direction of movement of the at least one hand of the passenger,
the at least one sensor being adapted to generate a signal representative of the at least one of the position of the at least one hand of the passenger and/or the configuration of the at least one hand of the passenger and/or the direction of movement of the at least one hand of the passenger;
a controller communicatively connected to the at least one sensor for receiving at least the signal therefrom,
the controller being communicatively connected to at least one passenger controllable feature, the controller being adapted to control the at least one passenger controllable feature based on the signal representative of the at least one of the position of the at least one hand of the passenger and/or the configuration of the at least one hand of the passenger and/or the direction of movement of the at least one hand of the passenger; and
a projector communicatively connected to the controller,
the projector being adapted to project a passenger interface onto a predetermined surface, placement of the projected passenger interface being determined by the controller based at least on the signal representative of the at least one of the position of the at least one hand of the passenger and/or the configuration of the at least one hand of the passenger and/or the direction of movement of the at least one hand of the passenger.

2. The system of claim 1, wherein the at least one sensor and/or the controller are adapted to determine an intended interaction with the passenger interface by the passenger based on a placement of the at least one hand of the passenger on the predetermined surface.

3. The system of claim 1, wherein the at least one sensor is adapted to determine an intended interaction with the passenger interface by the passenger based on movement of the at least one hand of the passenger between the projector and the predetermined surface.

4. The system of claim 1, wherein the at least one passenger controllable feature includes at least one of:
an overhead light; and/or
an air supply; and/or
a sound system with controllable volume; and/or
a window shade system for selectively closing and opening a window shade.

5. The system of claim 1, wherein:
the projector is a first projector;
the predetermined surface is a first predetermined surface; and
the system further comprises:
a second projector communicatively connected to the controller,
the second projector being adapted for projecting at least one media display onto a second predetermined surface.

6. The system of claim 5, wherein:
the first predetermined surface is a ledge generally adjacent to the seat; and
the second predetermined surface is a table top.

7. The system of claim 5, wherein:
at least a portion of the second predetermined surface is selectively moveable between at least a horizontal position and a tilted position; and
the second projector is adapted to project the at least one media display onto the portion when the portion is arranged in the horizontal position and when the portion is arranged in the tilted position.

8. The system of claim 5, wherein:
the second predetermined surface is selectively moveable between at least a deployed position and a stored position,
the second projector being adapted to project the at least one media display onto the second predetermined surface only when the second predetermined surface is arranged in the deployed position.

9. The system of claim 5, further comprising:
a third projector for projecting a visual media onto a wall surface disposed generally opposite the seat, the third projector being communicatively connected to the controller.

10. The system of claim 9, wherein the visual media is at least a portion of the at least one media display projected by the second projector.

11. The system of claim 9, further comprising at least one seat sensor communicative connected to the controller, the at least one seat sensor being adapted for determining at least one of:
a translational position of the seat;
a recline angle of the seat; and
a presence of the passenger in the seat.

12. The system of claim 9, further comprising at least one passenger sensor communicatively connected to the controller, the passenger sensor being adapted to determine at least one of:
a position of a head of the passenger; and/or
a position of a body of the passenger; and/or
a change in position of at least one of the head of the passenger and the body of the passenger.

13. The system of claim 1, wherein the passenger interface projects buttons for controlling at least one of:
a passenger controllable feature; and/or
an additional projector for projecting at least one media display onto a surface near the seat.

14. A system for providing a plurality of passenger interfaces for a passenger in a seat, the system comprising:
a first projector for projecting a button display onto a side ledge disposed near the seat;
a second projector for projecting a first media display onto a table top disposed near the seat;
a third projector for projecting a second media display onto a side wall opposite the seat;
at least one sensor adapted to sense at least one of:
a position of at least one hand of the passenger, and/or
a configuration of the at least one hand of the passenger, and/or
a direction of movement of the at least one hand of the passenger,
with respect to at least one of the button display and/or the first media display; and
a controller communicatively connected to the first projector, the second projector, the third projector, and the at least one sensor.

15. A method for providing a passenger interface to a passenger in a seat, the method comprising:
receiving, by a controller from at least one sensor, a first signal indicative of at least one of:
a position of the hand of the passenger, and/or
a position of an arm of the passenger;
projecting, by a projector, a passenger interface onto a predetermined surface, a location of the passenger interface on the predetermined surface being based on the first signal;
receiving, by the controller from the at least one sensor, a second signal indicative of at least one of a position of the hand of the passenger with respect to the passenger interface and/or a configuration of the hand of the passenger with respect to the passenger interface, and/or a direction of movement of the hand of the passenger with respect to the passenger interface; and
adjusting, by the controller, based on the second signal, at least one of:
a passenger controllable feature, and/or
projection of at least one media display by a second projector communicatively connected to the controller.

16. The method of claim 15, wherein the passenger interface is a projected button display.

17. The method of claim 15, wherein the second signal is indicative of the position of the hand of the passenger on the predetermined surface.

18. The method of claim 15, wherein the second signal is indicative of at least one of the position and/or the configuration and/or the movement of the hand of the passenger between the predetermined surface and the at least one sensor.

19. The method of claim 15, wherein:
the projector is a first projector;
the predetermined surface is a first predetermined surface; and
the method further comprises:
projecting, by a second projector, at least one media display onto a second predetermined surface.

20. The method of claim 19, wherein:
the second predetermined surface is selectively moveable between at least a deployed position and a stored position; and
the method further comprises:
detecting, by the at least one sensor, that the second predetermined surface is in the stored position; and
sending, from the controller to the second projector, a signal to control the second projector to stop projecting the at least one media display.

21. The method of claim 19, wherein:
at least a portion of the second predetermined surface is selectively moveable between at least a horizontal position and a tilted position; and
the method further comprises:
detecting, by the at least one sensor, that the portion of second predetermined surface is in the tilted position; and
adjusting the projection of the at least one media display, by the second projector, to project the at least one media display onto the portion in the tilted position.

22. The method of claim 19, further comprising projecting, by a third projector, a visual media onto a third predetermined surface.

23. The method of claim 19, further comprising:
receiving, by the controller from the at least one sensor, a third signal indicative of at least one of a position of the hand of the passenger with respect to the media display projected onto the second predetermined surface and/or a configuration of the hand of the passenger with respect to the media display projected onto the second predetermined surface and/or a direction of movement of the hand of the passenger with respect to the media display projected onto the second predetermined surface; and
projecting, by a third projector, a visual media onto a third predetermined surface, based on the third signal.

24. The method of claim 23, further comprising controlling the second projector to stop projecting the at least one media display onto the second predetermined surface when the third projector begins projecting the visual media onto the third predetermined surface.

25. The method of claim 23, further comprising:
receiving, by the controller from at least one seat sensor, a fourth signal indicative of at least one of:
a translational position of the seat, and/or
a recline angle of the seat, and/or
a presence of the passenger in the seat; and
adjusting projection of at least one of the first projector and/or the second projector and/or the third projector based at least on the fourth signal.

26. The method of claim 23, further comprising:
receiving, by the controller from at least one passenger sensor, a fourth signal indicative of at least one of:
a position of a head of the passenger, and/or
a position of a body of the passenger, and/or
a change in position of at least one of the head of the passenger and/or the body of the passenger; and
adjusting projection of at least one of the first projector, the second projector, and the third projector based at least on the fourth signal.
